(19) United States
(12) Patent Application Publication
(10) Pub. No.: US 2019/0379822 A1
(43) Pub. Date: Dec. 12, 2019

(54) CAMERA APPARATUS

(71) Applicant: 5l Corporation Pty. Limited, Mangerton, New South Wales (AU)

(72) Inventors: Sao Ian LEONG, Wollongong (AU); Deon Christopher DE SALDANHA, Wollongong (AU); John DIMESKI, Figtree (AU); Lupco RISTOV, Mangerton (AU)

(21) Appl. No.: 16/488,212

(22) PCT Filed: Feb. 23, 2018
(86) PCT No.: PCT/AU2018/050157

§ 371 Date: Aug. 22, 2019

(30) Foreign Application Priority Data
Feb. 23, 2017 (AU) 2017900610
May 26, 2017 (AU) 2017901997

(51) Int. Cl. H04N 5/232; H04M 1/725; G06F 3/01

(52) U.S. Cl. CPC H04N 5/23219; H04M 1/72569; H04M 2250/52; G06F 3/017; G06F 3/012

(57) ABSTRACT

The invention relates to a portable electronic device (101) including at least one camera (102) and an orientation sensor (104) for determining the orientation of the camera. When the camera is oriented in a predetermined orientation, the camera is actuated such that at least one image or a video stream is captured.

### FIELD OF THE INVENTION

The present invention relates to camera apparatus and in particular to a camera for more easily allowing a user to quickly actuate camera functions such as initiate a video recording or still photo capture, trim, crop, share photos and videos and control camera features such as playback and zoom.

The invention has been developed primarily for use in/with a camera installed in a portable electronic device such as a mobile phone, tablet computer or wearable device and will be described hereinafter with reference to this application. However, it will be appreciated that the invention is not limited to this particular field of use. Specifically it is noted that the invention can be used in more traditional camera apparatus.

### BACKGROUND OF THE INVENTION

Portable electronic devices such as mobile phones and tablets computers including camera functionality have become popular in recent years to the point where they can replace the need for a traditional camera for some users.

Professional and amateur photographers and videographers are always on the lookout for interesting photos and videos to capture. These can be for commercial or personal use and in some instances there is a desire or need to share the photo or video quickly via the Internet and through social media. This can be to share an action shot, news story, social event, commercial news, family event as fast as possible for either commercial and/or social-status gain.

In many instances potential photo or video shot opportunities (so called golden moments) occur unexpectedly and are not able to be captured because the user's camera is not ready or not able to be activated quickly enough. This leads to disappointment at the moment and opportunity being forever lost. For those who earn, or would wish to earn, an income based on sharing of newsworthy video content, there are positive financial consequences to being able to better capture, trim and share newsworthy content as fast as possible.

Some users fear losing out on a golden moment so choose to constantly record using their device in the hope they will eventually capture a photo or video of interest. This leads to complications with the devices as all devices have memory limitations, video length limits and image quantity and/or image size limits. In addition, lengthy videos often need to be extensively edited before being ready to be shared.

Even in the event that a good or golden moment is captured in this way the sharing of the photo or video becomes complex. Sharing may be possible by way of cloud storage services such as DropBox™ or Google Drive™ but in the event of video sharing the video segment often now contains long lengths of “unengaging” or “uninteresting” content leading up to the moment of actual interest. For example, if the user had been recording for 2 hours and then only 1 minute is of interest, the whole video must be uploaded causing wasted upload time, usage of data and difficulty in finding and playing only the content of interest. If a large file service is used, then large data charges can be incurred if using cellular data (expensive in some parts of the world), and engaging users to like and share the content is incredibly difficult. Ultimately, even if the file is sharable, the audience can be bored by the prelude/s leading up to the segments of interest. This means the content is less impactful than the user would like, and it also means less Facebook™ (and other social media) engagement (in the form of likes for example), less social kudos, less affiliate advertising income and the like.

A further difficulty is experienced in terms of the size of unedited video and photo filed in that they are generally too big to share via the preferred social network channels such as Facebook™. This requires editing in the form of post clipping or downscaling before being user is able to effectively share the photo or video. With this requirement either user time or quality in the video or photo is lost. This is especially frustrating for users where there is an increased demand for almost-live, and high quality, content.

With the increased number of cameras being available and cameras being incorporated into smart phones and tablet computers, the number of potential creators of content is rapidly increasing and they will increasingly be looking to share engaging content while faced with the potential problems mentioned above. In addition data networks may become increasingly congested with a rise in traffic leading to yet further delays as networks slow to deal with increased traffic.

Any discussion of the background art throughout the specification should in no way be considered as an admission that such background art is prior art, nor that such background art is widely known or forms part of the common general knowledge in the field in Australia or any other country.

### SUMMARY OF THE INVENTION

The preferred embodiment of the invention seeks to provide a camera apparatus that will overcome or substantially ameliorate at least some of the deficiencies of the prior art, or to at least provide an alternative.

There are estimated to be over 2 Billion smart phones in use globally, most equipped with a camera, many now able to record in 4K resolution. Apple™'s iPhone 7 Plus™, as an example, also incorporates optical zoom capability and optical image stabilization, making the capture of high quality content more possible by more people. As such better utilization of the capabilities of smart phones and tablet computers is one manner in which to achieve improvements over the prior art. Advantageously preferred embodiments of the invention seek to improve the ability to capture and share desirable content more easily. Advantages include; minimizing the camera apparatus startup time and restart time; ensuring that video length is either auto limited or optionally user limited; providing for post capture clipping options that are user friendly and fast (almost instantaneous), providing for live clip and/or share options that are user friendly and fast so as to address the high impact and instant-hit content demands and shortened attention spans of many modern consumers; optionally as an alternative to clipping, provide bookmarking of video files for users who prefer the option of viewing only the highlights or the entire footage; allowing video and photo sharing to be seamless and more efficient.

Embodiments of the invention can advantageously be applied to many different scenarios and assist users in capturing and sharing videos and images in relation to the following non exhaustive list of scenario examples: children; sport; unusual everyday life events; occupational health and safety (including in a building environment); accidents; incidents; law enforcement.

In some embodiments, the invention is implemented using existing hardware and software as an application, in some instances it is embedded in the device settings and in other embodiments it is implemented as part of a fully integrated device. In some embodiments the invention is implemented into existing device settings by way of a software upgrade or hardware retrofit or both.

According to a first aspect of the present invention there is provided a camera including: a body; a lens mounted to the body for receiving light; an image sensor for receiving an optical image created by the light and converting the optical image to image information in the form of an electrical signal; a memory in communication with the image sensor for storing the image information; an orientation sensor for determining the orientation of the lens with respect to the horizontal; and an actuator for automatically actuating the camera such that at least one image is captured and stored in the memory when the orientation of the lens with respect to the horizontal passes a predetermined angle. Preferably upon actuation the camera captures a series of images in the form of a video. Preferably the camera includes a microphone for capturing sound and converting the sound to sound information in the form of an electrical signal wherein the sound information is stored on the memory and associated with its respective image information. Preferably the camera includes a shutter release for selectively allowing light to pass through to the image sensor wherein the actuator is in communication with and automatically actuates the shutter release.

According to a second aspect of the invention there is provided a portable electronic device including: a body; a camera mounted to the body; an orientation sensor for determining the orientation of the camera; an actuator for actuating the camera when the camera is oriented in a predetermined or adaptive activation orientation. Preferably the actuation is a camera video recording or image capture. Preferably the portable electronic device includes a memory for storing at least one photo or video that is captured when the camera is actuated. Preferably the camera is deactivated when the camera is oriented in a predetermined deactivation orientation. Preferably the deactivation deactivates or pauses the camera video recording or image capture. Preferably the orientation sensor determines the orientation of the camera with reference to the horizontal. Preferably the activation orientation is between about 50 degrees and 63 degrees with reference to the horizon. Preferably the deactivation orientation is between about 60 and 64 with reference to the horizon. Preferably upon deactivation the user is provided with options to save and/or trim and/or edit and/or distribute the photo and/or video. Preferably the options can be selected without touching the user interface. In some embodiments other activation methods are used including touch activation, touch screen activation or use of physical buttons.

According to a third aspect of the invention there is provided a portable electronic device including: a display for displaying a image to a user; a camera to take a photo of the user's face wherein the image displayed on the display is edited according to the characteristics of the user's face. Preferably the image displayed to the user is a video. Preferably the editing is done according to changes in the characteristics of the user's face. Preferably the changes in characteristics of the user's face includes one or more of; the user's face height to screen height ratio; and the rate of change of the face height to screen height ratio or other activation method. Preferably the rate of change of the face height to screen height ratio is used to determine the distance of the user's face from the display. Preferably the rate of change of the face height to screen height ratio is used to determine the speed of movement of the user's face relative to the display. Preferably the image displayed on the display is edited to: change the zoom in and/or out. Preferably the image displayed is stored in the memory. Preferably the image forms a video and the video displayed on the display is edited to: replay and/or rewind and/or forward the video; adjust the replay speed slower and/or faster of the video; change the zoom in and/or out of the video.

According to a fourth aspect of the invention there is provided a portable electronic device including: a display for displaying an image or live recording to a user; a camera to continually observed the user's face wherein the image displayed on the display and/or recorded is edited according to the characteristics of the user's face. Preferably the image displayed to the user is a video. Preferably the editing is done according to changes in the characteristics of the user's face. Preferably the changes in characteristics of the user's face includes one or more of; the observed distance (measured as the view-angle between features for any given lens focal length for the user facing camera) between user facial features (for example, distance between and eye (or reading glasses or sunglasses) and/or other eye (or reading glasses or sunglasses) and/or chin and/or crown and/or nose and/or mouth; and/or the rate of change of the observed distances. Preferably wherein the change and/or rate of change of the observed distanced are used to control the camera, to achieve for example zooming and/or cropping. Preferably the image displayed on the display and/or captured/recorded is edited to: change the zoom in and/or out. Preferably the image displayed is stored in the memory. Preferably the image forms a video and the video displayed on the display is edited to: replay and/or rewind and/or forward the video; adjust the replay speed slower and/or faster of the video; change the zoom in and/or out of the video.

According to a fifth aspect of the invention there is provided a portable electronic device including: a body; a camera mounted to the body; a sensor for determining at least one activation or deactivation criterion; an actuator for actuating or deactivating the camera according to the activation or deactivation criteria. Preferably the sensor is one or more of the following: orientation sensor; light sensor; motion detector; global positioning system; proximity sensor; sound sensor; touch sensor; ultrasonic sensor; gyroscope; accelerometer; light sensor; visible light sensor; invisible light sensor (infrared, ultraviolet, invisible light spectrum); sound wave; microphone; ultrasonic; thermostat/temperature; electro conductivity; electro resistance; pressure; optics. Preferably the criteria include one or more of the following individually or in combination: raise to start; light sensing; machine learnt predefined motion; gesture recognition; facial distance determination; facial recognition; voice recognition; and sound recognition.

According to a sixth embodiment of the invention there is provided a camera including: a body; an image sensor for receiving an optical image created by the light and converting the optical image to image information in the form of an electrical signal; a memory in communication with the image sensor for storing the image information; an orientation sensor for determine the orientation of the lens with respect to the horizontal; and an actuator for automatically actuating the camera such that at least one image is captured and stored in the memory when the orientation of the lens with respect to the horizontal passes a predetermined angle or an adaptively derived angle derived through multiple factor-based computation.

According to a seventh aspect of the invention there is provided a portable electronic device including: a body; a camera mounted to the body; an orientation sensor for determining the orientation of the camera; an actuator for actuating the camera when the camera is oriented in a predetermined or adaptive activation orientation. Preferably the actuation is a camera video recording or image capture. Preferably the portable electronic device includes a memory for storing at least one photo or video that is captured when the camera is actuated. Preferably the camera is deactivated when the camera is oriented in a predetermined deactivation orientation. Preferably the deactivation deactivates or pauses the camera video recording or image capture. Preferably the orientation sensor determines the orientation of the camera with reference to the horizon. The activation orientation is related to the direction the camera is facing: in the case of a smart phone as an example, the orientation is equal to the moment when the device is oriented with the intention to capture a video. In this instance, activation occurs when the camera is approaching or pointing towards the angle where the object of interest can be video-recorded. These activation angles can be between 45 to 135 degrees to the horizon. Deactivation angles can be between 45 to 0 degrees to the horizon. The actual activation and deactivation angles in used can be adaptive, computed with a combination of predetermined values, user preferences, machine learning, average from multiple users, location based (capturing Sydney Tower requires a large angle). Preferably upon deactivation the user is provided with options to save and/or trim and/or edit and/or distribute the photo and/or video. Preferably the options can be selected without touching the user interface. In some embodiments other activation methods are used including touch activation, touch screen activation or use of physical buttons.

According to an eighth aspect of the present invention there is provided a camera including: a body; an optional lens, pinhole, mirror, or other optical, mechanical or electronically means to ensure that an image is focused onto an image sensor; an image sensor for receiving an optical image created by the light and converting the optical image to image information in the form of an electrical signal; a memory in communication with the image sensor for storing the image information; an orientation sensor for determine the orientation of the lens with respect to the horizontal; and an actuator for automatically actuating the camera such that at least one image is captured and stored in the memory when the orientation of the lens with respect to the horizontal passes a predetermined angle. Preferably upon actuation the camera captures a series of images in the form of a video. Preferably the camera includes a microphone for capturing sound and converting the sound to sound information in the form of an electrical signal wherein the sound information is stored on the memory and associated with its respective image information. Preferably the camera includes a shutter release for selectively allowing light to pass through to the image sensor wherein the actuator is in communication with and automatically actuates the shutter release.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 shows a portable electronic device on which the various embodiments described herein may be implemented in accordance with an embodiment of the present invention;

FIG. 2 shows a side view of the portable electronic device of FIG. 1 on which the various embodiments described herein may be implemented in accordance with an embodiment of the present invention;

FIG. 3 is a flow diagram showing processing steps in accordance with a preferred embodiment of the present invention;

FIG. 4 is a user interface in accordance with another preferred embodiment of the present invention;

FIG. 5 is a user interface in accordance with another preferred embodiment of the present invention;

FIG. 6 is a user interface in accordance with another preferred embodiment of the present invention;

FIG. 7 is a user interface in accordance with another preferred embodiment of the present invention;

FIG. 8 is a user interface in accordance with another preferred embodiment of the present invention;

FIG. 9 is a user interface in accordance with another preferred embodiment of the present invention;

FIG. 10 is a user interface in accordance with another preferred embodiment of the present invention;

FIG. 11 is a user interface in accordance with another preferred embodiment of the present invention;

FIG. 12 is a user interface in accordance with another preferred embodiment of the present invention;

FIG. 13 is a user interface in accordance with another preferred embodiment of the present invention;

FIG. 14 is a user interface in accordance with another preferred embodiment of the present invention;

FIG. 15 is a user interface in accordance with another preferred embodiment of the present invention;

FIG. 16 shows the image sensor dimensions for a portable electronic device according to another preferred embodiment of the present invention, together with the facial dimensions of a face captured by the image sensor;

FIG. 17 shows example image sensor readings for a portable electronic device according to another preferred embodiment of the present invention;

FIG. 18 is a user interface in accordance with another preferred embodiment of the present invention;

FIG. 19 is a user interface in accordance with another preferred embodiment of the present invention;

FIG. 20 shows exemplary device movement to initiate zoom functionality of a portable electronic device in accordance with another preferred embodiment of the present invention;

FIG. 21 shows sample accelerometer data from a portable electronic device in accordance with another preferred embodiment of the present invention;

FIG. 22 shows a diagrammatic view of touch controller operation for zoom functionality control in accordance with another preferred embodiment of the present invention;

FIG. 23 shows an exemplary method of zoom functionality control in accordance with another preferred embodiment of the present invention;

FIG. 24 shows a diagrammatic view of touch controller functionality n in accordance with another preferred embodiment of the invention.

### DESCRIPTION OF EMBODIMENTS

It should be noted in the following description that like or the same reference numerals in different embodiments denote the same or similar features.

One preferred embodiment provides a portable electronic device including a body and a camera mounted to the body. The device includes a sensor for determining at least one activation or deactivation criterion and an actuator for actuating or deactivating the camera according to the activation or deactivation criteria. The sensor is chosen from one or more of the following: orientation sensor; light sensor; motion detector; global positioning system; proximity sensor; sound sensor; touch sensor. Example sensor types can be any suitable type of sensor that is chosen according to the predetermined use of the device The criteria for activating and deactivating the camera include one or more of the following individually or in combination: raise to start; light sensing; machine learnt predefined motion; gesture recognition; facial distance determination; facial recognition; voice recognition; machine learning; and sound recognition.

The preferred embodiment of the invention provides quick or almost instant activation of the camera on a mobile phone or other portable electronic device. The activation is preferably done by way of touchless controls according to predetermined sensor readings from a sensor on the mobile phone wherein when the sensor senses the predetermined activation or deactivation criterion the camera immediately commences recording video or taking photos until the sensor detects the deactivation criterion. In some embodiments the activation sensor and the deactivation sensor are the same sensor but in other embodiments the activation sensor and the deactivation sensor are different sensors and different types of sensors. For example, the activation sensor and activation criterion could be that the camera is activated based on the orientation of the phone sensed by an orientation sensor and the deactivation sensor and deactivation criterion could relate to a light sensor wherein the camera is deactivated when the light sensor detects low light or no light conditions.

In a preferred embodiment one or more sensors are used to activate one or more features of the device, including zoom features, playback features, editing features, video/photo sharing features. Providing touchless controls leads to better quality photos and videos as the user does not need to touch a user interface which may cause the camera to move which can lead to poor camera results. The touchless controls work by utilizing sensors and determining criteria as defined above and includes, for example, determining certain facial characteristics, ultrasonic sensors, voice controls, brain waves, facial gestures and the like. In this embodiment the device provides an instant clip and/or editing feature that is activated when the recording stops. As soon as the deactivation criterion is activated and the recording stops the editing feature is activated. In the editing feature the user can edit or clip the video just recorded in a touchless environment using any of the sensor types disclosed and can then also share the video through a social media website or Internet channel without touching the user interface. This allows the user to start and stop recording quickly, edit the video quickly and share the video quickly.

Actuation or triggering of the camera can be done by way of continuous monitoring of input, input-sequence, gesture and gesture-sequence from one or more sensors. Sensors include but are not limited to an accelerometer, gyroscope, visible light sensor or array of visible light sensor, invisible light sensor (e.g. infrared, ultraviolet sensor, the invisible light spectrum), sound wave sensor (microphone or ultrasonic), thermostat (temperature), electro-conductivity sensor, electro-resistance, pressure sensor (squeeze), optics sensor (any electromagnetic spectrum), biosignal sensors including, but not limited to, Electroencephalogram (EEG), Electrocardiogram (ECG), Electromyogram (EMG), Mechanomyogram (MMG), Electrooculography (EOG), Galvanic skin response (GSR), Magnetoencephalogram (MEG). The monitoring of triggers includes both single value and sequence of value against either a set of fix thresholds or a set of adaptive thresholds. Adaptive thresholds adjust themselves through the input from the same sensor or other sensor or any combination thereof.

In this document, an input is a quantitative value in the format of data or collection of a data set. A sequence is referred to as a collection of inputs in an order. The order is preferably chronological order, but is not limited to this type. A gesture can be classified from a collection of inputs, e.g. accelerometer/gyroscope and input/input-sequences that represent the change of orientation. A gesture-sequence can be classified from a collection of gestures. Actuation can be adaptive or predetermined and can be defined from sensor input values, input-sequences, gestures or a combination thereof for the purposes of but not limited to capturing video and photos. The logic of fix and adaptive monitoring can be implemented in, but not limited to, software, hardware, firmware, mechanical, electronically, wave form. For example, preference settings in a smart phone, firmware, embedded electronic device.

Embodiments of the invention can be implemented in an electronic device, retro-fitting with software update to existing devices, made available through electronic components modification, external software component or external hardware component or any combination of the above. Portable electronic devices refer to standalone devices, e.g. but not limited to smart phone, smart watches, digital cameras, digital glasses, action cameras and the like. Portable electronic devices also include external peripherals for electronic devices,/mechanical devices, analog devices, in electronic hardware or software, firmware or any combination of the above. The actuator and the triggered imagery capture can be part of the form factor for a standalone piece of electronic device. The actuator and the triggered imagery capture can be connected via wired or wireless communication as separated devices.

In an embodiment using the angle of orientation of the camera as the trigger or actuator, the trigger angle can be predetermined or user defined. The trigger angle can be adaptive and adjusted according to the user input, other sensor input, software update, a temporary configuration, or any combination thereof. For example, the range of between about 50 to 63 degrees to the horizontal can be used as one of the initial trigger value ranges for activating or initiating the video capture, while the range of about 60 to 44 degrees to the horizontal can be used as one of the initial trigger value ranges for deactivating or stopping the video capture. In another embodiment the range of about 45 to 60 degrees to the horizontal can be used as an activation trigger and the range of about 30 to 10 degrees is used as the deactivation trigger. As would be understood these ranges are given by way of example only and other range angles can be chosen according to different embodiments and for different applications.

One preferred embodiment of the invention provides a camera in the form of a smart phone or tablet computer. The smart phone includes a body and a lens mounted to the body for receiving light. An image sensor receives an optical image created by the light and converts the optical image to image information in the form of an electrical signal. A memory is in communication with the image sensor for storing the image information. The phone includes an orientation sensor for determining the orientation of the lens with respect to the horizontal and an actuator for automatically actuating the camera such that at least one image is captured and stored in the memory when the orientation of the lens with respect to the horizontal passes a predetermined angle. Upon actuation the camera captures a series of images in the form of a video. The phone further includes a microphone for capturing sound and converting the sound to sound information in the form of an electrical signal wherein the sound information is stored on the memory and associated with its respective image information. As would be understood, an optical image refers to an image formed by the refraction or reflection of light.

In some embodiments, when implemented in an SLR for example, the camera includes a shutter release for selectively allowing light to pass through to the image sensor wherein the actuator is in communication with and automatically actuates the shutter release.

A preferred embodiment of the invention uses a portable electronic device in the form of a mobile phone such as an iPhone™, Android™ device, Windows™ device or Samsung™ phone having a camera or camera facility already built into the phone. Depending on the configuration of the phone and the existing hardware available the invention can either be implemented as an upgrade of the phone and/or can be implemented by means of a software application and/or by means of a hardware plug-in into an expansion port and/or software application.

In an embodiment implemented with an iPhone™ 7 plus smart phone, the implementation is done by way of a software application installed on the phone. The software is either installed as an application on the phone or further embedded into the phone by way of a settings level integration. The iPhone provides a plurality of cameras fixedly mounted in the case of the phone. A user can use any one of the cameras to take photos and videos by unlocking the phone, activating the camera application and then actuating the camera to record a video or take a photo. The phone includes an orientation sensor that is utilised by the application to determine the orientation of the lens with respect to the horizontal. The application determines the relevant angle at which the phone and specifically the camera lens is held and actuates the camera once the lens passes a predetermined angle. While in this example an orientation sensor is used, any suitable type of sensor can be used to activate or deactivate the camera according to the particular application the apparatus is being used for. In the example of an orientation sensor, the predetermined angle is chosen so as to ensure that the lens is pointed in a direction and at an angle that is particularly suited to capturing video and photos in the line of sight of the user. The application includes an actuator function for automatically actuating the camera such that at least one image or a video stream is captured and stored in the memory when the orientation of the lens with respect to the horizontal passes a predetermined or adaptive angle. In this embodiment the software application can be run as an application running on the phone or can be integrated into the operating system of the software. In both these instances the application software can be set to run in the background and simultaneously with the operating software and other application software so as to ensure virtually instant startup and activation of the camera. In this manner, when the phone is raised past a predetermined or adaptive angle the camera is activated and starts to record and take video and/or photos. When the phone is lowered again past a predetermined or adaptive angle, the camera is either paused or stopped. This option can be user definable or can be predetermined or adaptively determined by the provider of the phone. In this implementation software according to the invention implemented on a phone, it is preferred that while the camera is recording or taking photos that the call feature of the phone is deactivated or at least placed on hold so that receiving a phone call does not interrupt the video recording or photograph. In this way recording cannot be interrupted by untimely phone calls.

A preferred embodiment includes features to allow the user to easily and quickly clip the video recorded. This quick clipping allows the user to store only the portion of the video that is deemed to be of interest and facilitates easier sharing of the video. To allow the user to easily clip the video once the user has finished recording the desired event, the user lowers the phone. The lowering of the phone is detected by the orientation sensor and the system automatically turns off the video recording without further user intervention and presents the user with a number of options, including how to clip and edit the video recorded. The recording can optionally be stopped or paused according to user preferences. Some of the options provided to the user when the phone is lowered are as follows: stop the recording when the phone is lowered (for example, if default is set as pause); pause the recording when the phone is lowered (for example, if default set as stop); Clip last X, Y, or custom Z seconds, or do nothing. These options disappear after a few seconds and X and Y may be user definable according to user preferences. A save all function is available to set the apparatus to save all recorded video by default. When this is used in conjunction with clipping, then clip-point bookmarks are recorded for the full file. These are large action buttons that pop up in the screen. Custom Y can be set using simple finger slider or + − buttons. Users with large memory capacity have the option to have the unclipped full file video versions saved as well. Programmable shake sequences and/or facial gestures and/or voice commands can also be used instead of buttons.

In a preferred embodiment validation can be used to time, date and location stamp each image or video. The validation can be implemented by any validation or encryption including server encryption to verify the time stamp; RSA encryption; bock chain encryption and the like. In this way video and photographs can be verified and the proliferation of fake news prevented.

In a preferred embodiment of the invention, the user may be provided with detailed information regarding an event they are attending and recording. This functionality may be used, for example, to provide updates and outcomes at sporting events. In this embodiment, GPS is used to validate the position of the camera user and the user location is checked against preset data of major global events to identify the event being recorded by the user using the invention. Preset event data may, for example, include the publically available sporting schedules for major leagues in Football, Baseball, Basket, Soccer, NFL, and AFL. This preset event data can be used as a reference to provide a third party streaming service regarding key scoring data. This embodiment includes an API to link the identified event to the detailed information provided to the user. This detailed information is likely generated by a third party who may be a live score site on agreement or a live betting agency sourcing live data. There are key items of information a user typically seeks during and post an event, namely the final score, half time/full time statistics, and the ladder within the respect league as the user can reference where their team sits during the season.

This embodiment includes capturing a video recording of event as described above using an electronic device, however, once the event has concluded, the data provided is engaged to provide interesting or useful information, for example, as listed above for a sporting game. When the user is presented with the video for editing, they will be prompted to activate embedding of any available data into the video to allow it to be saved for future reference. One benefit of this embodiment concerns the later recollection of the sporting outcome and thus bypasses the need to conduct a search of historical results. Sponsor details could also be included in the embedded data, allowing the opportunity to generate advert revenue.

An alternative use for this embodiment extends to tourism diaries, where users can record videos and embed data regarding the location, historical details, and items of interest. This provides detail to supplement the personal cataloguing of one's life. Opportunity also exists for the source of embedded data to provide tourism offers to the user upon the data being accepted.

Embodiments of the invention provide advantages by way of a one-step startup to initiate camera recording in the way of photos or video. This provides the user with a fast reaction time when the user needs to record something of interest. It also provides the user with a device that is easier to use than the prior art. This is provided by way of any one or any combination of: orientation sensing; predefined device motion sequence; user defined device motion sequence; light sensing; face detection using user facing camera; user facial gesture recognition (e.g. smile recognition) using user-facing camera and if the user facing camera deters a face at any time; user voice commands.

Embodiments of the invention provide advantages by way of one step recording stop or pause. This is provided by way of any one of or any combination of: orientation sensing; predefined device motion sequence; user defined device motion sequence; light sensing; user facial gesture recognition (e.g. smile recognition using the user facing camera); user voice command.

Embodiments of the invention provide advantages by way of touchless control wherein there is no requirement to touch the device screen and/or control buttons, which may be used to control, for example, when recording (zoom in, zoom out), when capturing picture in video (cropping), when replaying video (fast forward, reverse play, fast rewind). This provides user benefits by way of better video recording quality though minimizing impact forces on the device caused by touching screen based or physical buttons. This also provides the user with an easier to use and more intuitive functionality. This is implemented by way of facial distance detection using: image size analysis using data from the user facing camera via determination of the viewing angle occupied by an image characteristic, for example face size, face height, distance between eyes, eye-nose-eye triangle, eye-mouth-eye triangle. If the user's face is further away, the view angle will be smaller; sonic based distance measurement; laser based distance measurement; rate of change of facial distance, using data as mentioned above as distance measuring mechanisms; user facial gesture recognition (e.g. smile recognition using the user facing camera; user voice commands.

Embodiments of the invention provide advantages by way of one step multi option, and/or automatic video trimming during any or all of: recording, post recording, during pause, during playback or playback pause. This is provided by way of one or more of the following: screen based buttons; device based buttons; user facial gesture recognition (e.g. smile recognition) using user-facing camera; user voice commands.

Embodiments of the invention provide advantages to users who, either temporarily or permanently, lack manual dexterity in their hands and/or the ability to easily use a touch screen or button controls. This may be, for example, due to a physical or mental disability affecting the hands, in situations where a user is wearing gloves, or where a user is under water. Embodiments of the invention advantageously allow users in such scenarios to record video and/or take pictures without requiring small dextrous movements or operational access to a touch screen. Embodiments of the invention can advantageously be used in underwater environments with water resistant electronics devices and in hazardous environments where a protective device case and/or gloves may be required that restrict access to manual controls.

Embodiments of the invention provide additional features including: fast start, stop; blooper disposal; zooming; photo in video capture; photo cropping; file sharing; changing replay speed; replay fast forward; and replay rewind. These are provided by one or more of the following sensors: touch; motion; voice; facial gesture recognition; light detection.

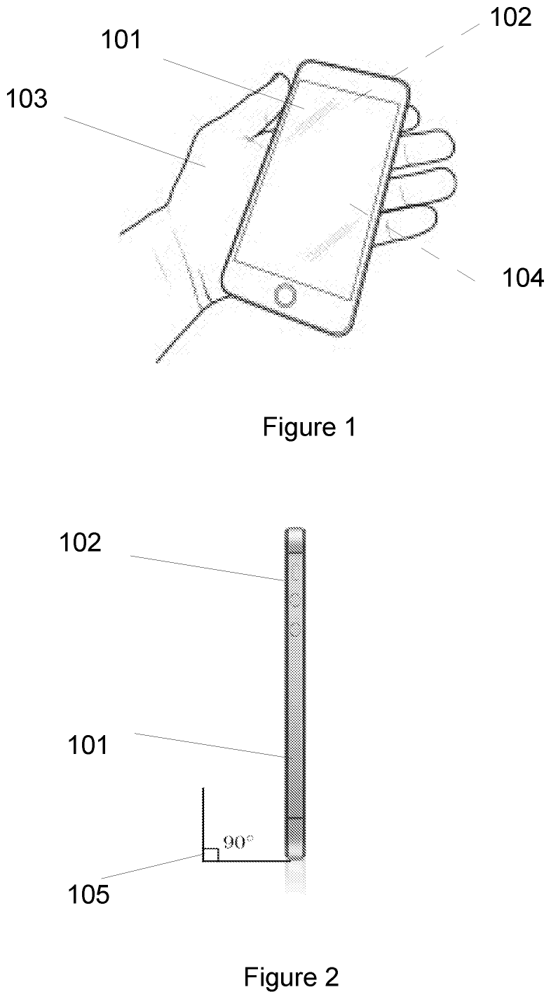

Referring to FIGS. 1 and 2 there is shown a camera apparatus in the forms of a portable electronic device being iPhone™ mobile phone 101. The phone 101 includes a plurality of cameras fixedly mounted to the case of the phone. For this example, rear facing camera 102 is mounted to the back of the phone and generally faces away from the user 103. It would be understood that embodiments of the invention can use one or more of the cameras provided in the mobile phone such as the front facing camera and/or one or more of the rear facing cameras according to user preferences. Referring to FIG. 2 the phone 101 is shown being held vertical at approximately 90 degrees with respect to the horizontal and includes an orientation sensor 104 built into the phone that is utilised to determine the orientation of the camera lens 102 with respect to the horizontal. In this embodiment the camera lens is mounted substantially flush with the back of the phone such that when held upright the camera lens captures images at substantially a right angle 105 with reference to the horizontal. This is approximately the view that the user looks at when standing straight. The apparatus determines the relevant angle at which the phone and specifically the camera lens is held and actuates the camera once the lens passes a predetermined angle. The predetermined angle is chosen so as to ensure that the lens is pointed in a direction and at an angle that is particularly suited to capturing video and photos in the line of site of the user. The preferred angle at which recording is actuated is between about 45 degrees and about 134 degrees. The application includes an actuator function for automatically actuating the camera such that at least one image or a video stream is captured and stored in the memory when the orientation of the lens with respect to the horizontal passes a predetermined angle.

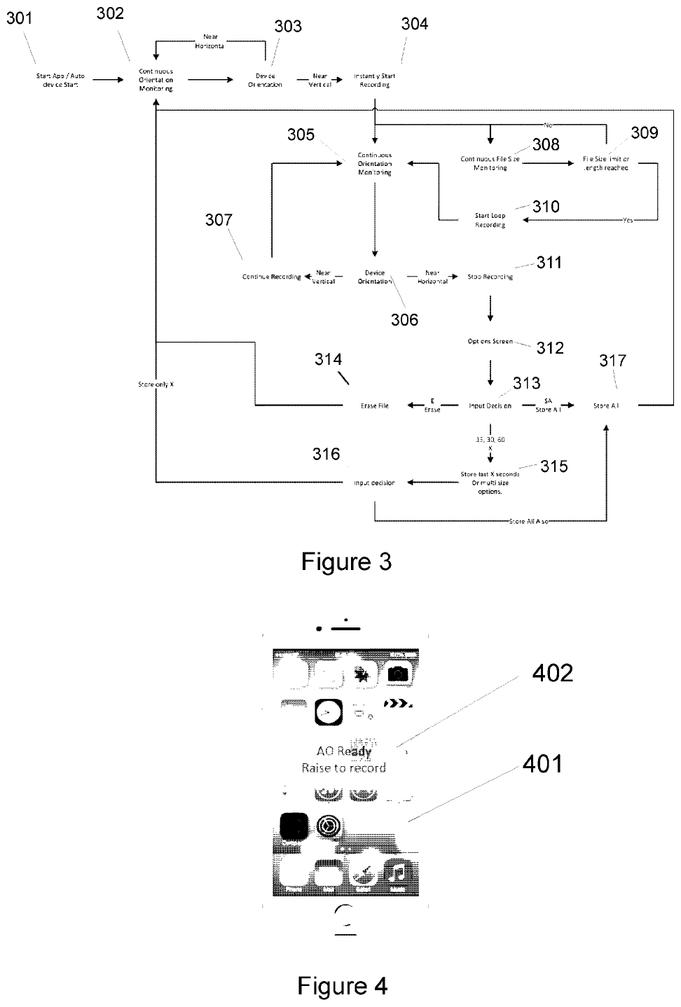

Referring to FIG. 3 there is shown a flow diagram showing processing steps in accordance with a preferred embodiment of the present invention. The apparatus commences operation at step 301 when the device is actuated. At step 302 the device continuously monitors the orientation of the camera and the determination of the orientation is made at step 303. If the orientation is near or about horizontal then the device continues to monitor the orientation. If the orientation is near or about vertical then recording is actuated at step 304. Once recording of the video starts the size of the video file is monitored at 308 and at the determination step 309 recording continues if the size limit has not been reached. If the file size limit has been reached the process continues at step 310 where loop recording is started. Loop recording maintains predetermined file size and/or time (for example a looped recording of 2 minutes meaning that only the last 2 minutes of video are kept and any older video for that particular recording is purged to maintain the file and/time limits). At step 305, while simultaneously recording, the device continuously monitors the orientation of the camera with the determination of the orientation being made at step 306. If the device is still near vertical then recording continues at step 307. If the orientation is changed to near horizontal then the recording stops/pauses at step 311. Once recording stops the option screen is presented to the user at step 312 and the user makes their determination at step 313. If the user elects to erase the recording the device proceeds to step 314 and then returns to step 302. If the user elects to store all, the entire video recording is kept and the device proceeds to step 317 before returning to step 302. If the user elects to store only the last portion of the video, for example the last 15, 30, 60 or x (where x is predetermined by the user) seconds then the device proceeds to steps 315 and 316 where the video file is cropped according to the user input. Only the selected recording length is stored, the remainder being purged from memory, after which the device returns to orientation monitoring at step 302.

FIG. 4 shows the user interface of a camera apparatus in the form of a mobile according to an embodiment of the invention. The mobile phone and camera is held vertically and the device is shown in the state of continuous orientation monitoring, represented by step 302 in FIG. 3. In this embodiment indication that the apparatus is ready to record is displayed on the screen 401 by way of notification 402.

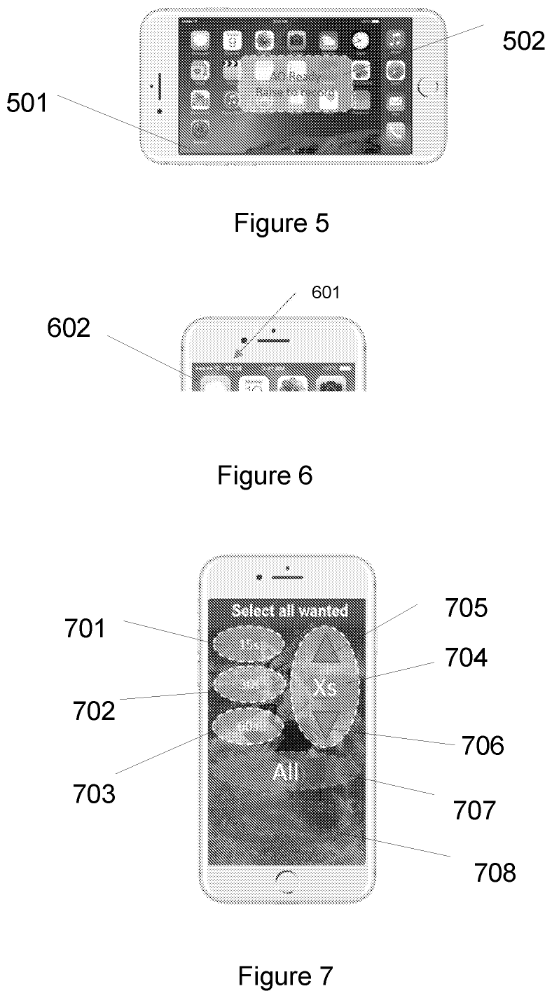

FIG. 5 shows the user interface of a camera apparatus in the form of a mobile according to an embodiment of the invention. The mobile phone and camera is held vertically and the device is shown in the state represented by step 302 of FIG. 3. In this embodiment indication that the apparatus is ready to record is displayed on the screen. In this embodiment indication that the apparatus is ready to record is displayed on the screen 501 by way of notification 502.

FIG. 6 shows the user interface of a camera apparatus in the form of a mobile according to an embodiment of the invention. In this embodiment an indication that the apparatus is to record is shown by way of indicator 602 in the main indicator bar on the top of the screen 601. In this instance the notification is denoted by the term AO and the indicator will show “AO-ON” or “AO-OFF” according to the state of the apparatus.

FIG. 7 shows the user interface of a camera apparatus in the form of a mobile according to an embodiment of the invention. Screen 701 is shown in the state represented by step 315 of FIG. 3 where the apparatus has recorded a video, the video has now stopped and the user is provided with the option of how much video they wish to keep. The user can select to keep one or more of 15 seconds, 30 seconds, 60 seconds or more of video by selecting the appropriate respective button 701, 702, 703 or 704. When selecting button 704 to store more or less than the predefined number of seconds the user has the option to change the amount of stored video using buttons 705 and 706. The user can select to store all the video options by selecting button 707 and storing none of the video by selecting button 708.

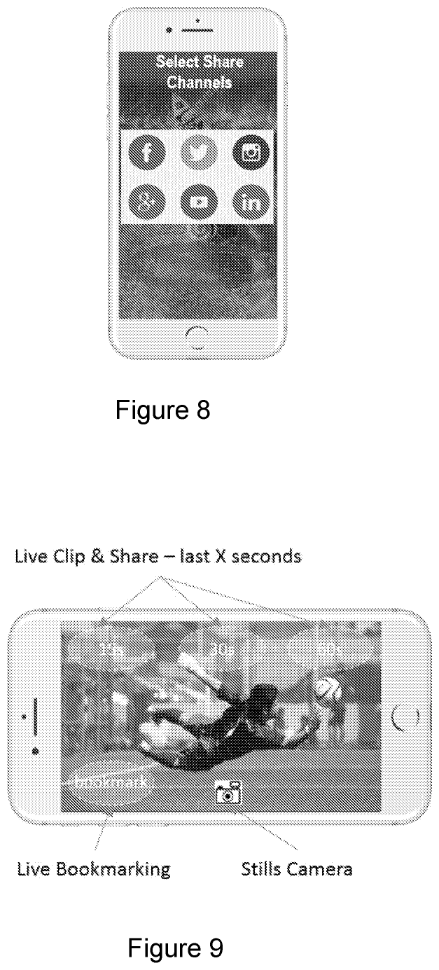

FIG. 8 shows the user interface of a camera apparatus in the form of a mobile according to an embodiment of the invention. Once the user has captured the desired photo and video, the user interface allows the user to share the photo or video by way of social media such as Facebook, LinkedIn, Twitter, Youtube and the like or by traditional messaging system systems such as MMS, SMS or email.

FIG. 9 shows the user interface of a camera apparatus in the form of a mobile according to an embodiment of the invention. This figure shows the function of live bookmarking, which is the ability to create bookmarks during the recording (live) so that it is easy to find the key action sequences when reviewing and/or replaying. Bookmarks may be created by any of the following commands: touch; voice command; and facial gestures. There is also the ability to erase only the last bookmark using the same type of commands. Bookmarking can also be reviewed with the ability to add, delete or amend bookmarks during replay of the recording.

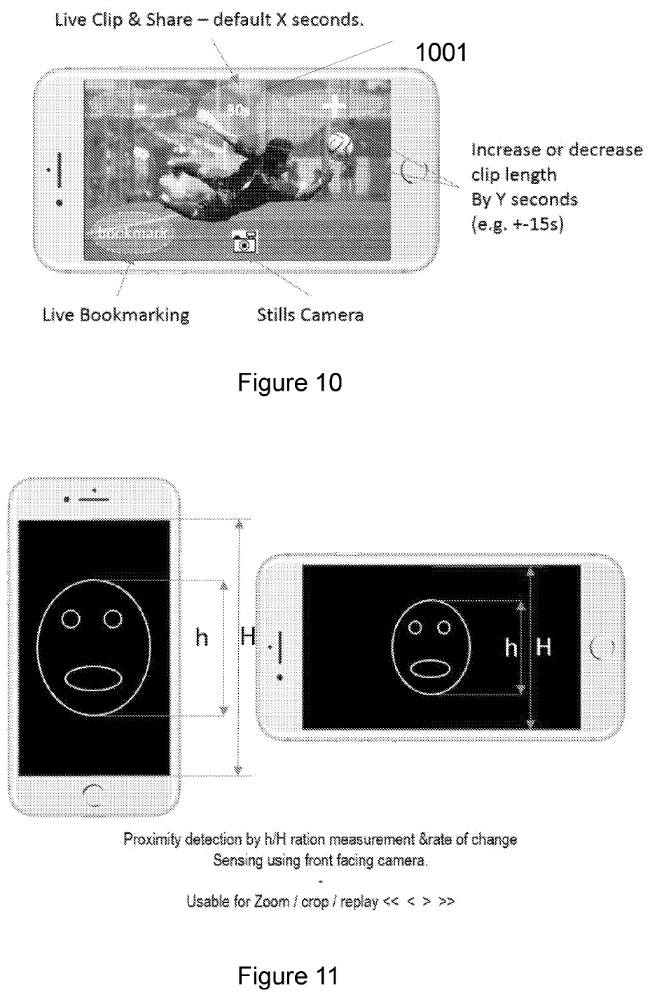

FIG. 10 shows the user interface of a camera apparatus in the form of a mobile according to an embodiment of the invention. This figure shows the function of live clipping and sharing. Live clipping allows the user to clip and share content without interrupting the recording process. In the touch activated version shown in FIG. 10, clip buttons 1001 allow the user to instantly clip and share content. Users also have the ability to pre-define sharing mechanisms so that sharing is easily automated. For example in some embodiments the user interface shows a ‘share now using Facebook’ button whereby the video clip is immediately shared through the user's Facebook account without further need for login or registration. FIG. 10 shows an example user interface for touch based live clip and share, live bookmarking and photo during video. When the bookmark button is pressed, the user is also prompted to select a clip length using flashing indicator buttons.

FIG. 11 shows the user interface of a camera apparatus in the form of a mobile according to an embodiment of the invention. This figure shows the function of touchless zoom that does not require the user to use an additional hand or finger to zoom in or out of a recording or photo. The touchless zoom feature is activated by way of non contact means including: measuring the distance the device is from the user's face and then monitoring this distance and adjusting the zoom according to whether the user's face gets closer or further away from the device. This can be achieved by using the front facing camera of the device; facial gestures determined by the front facing camera of the device including detection of eye blink sequences; and voice activation using specific works and/or sounds.

FIG. 11 illustrates the functioning of the touch command feature with the specific command for touchless zoom utilising the face height to screen height ratio, and the rate of change of that ratio to determine distance from and speed of screen relative to face. Similarly, the touchless command functionality can be used as a control mechanism to control other aspects of the application such as photo cropping, replay speed (slow and fast), replaying of the video, video rewind and fast forward and in video zooming.

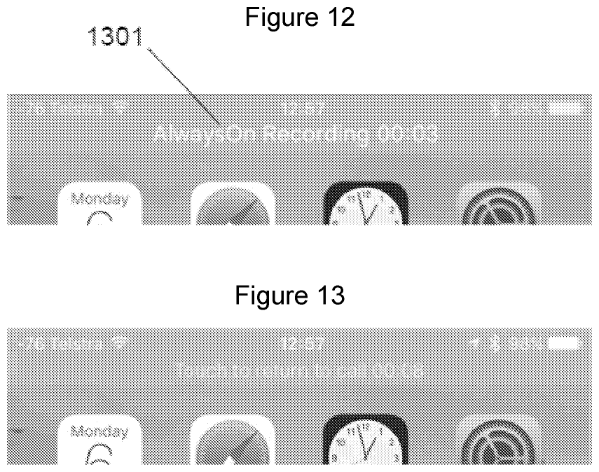

FIG. 12 shows a user interface with an indicator 1301 on the home screen signalling to the user that a recording session is running in the background for the application. This makes the user aware that the recording is active in the background and also allows easy access to return to the application recording interface.

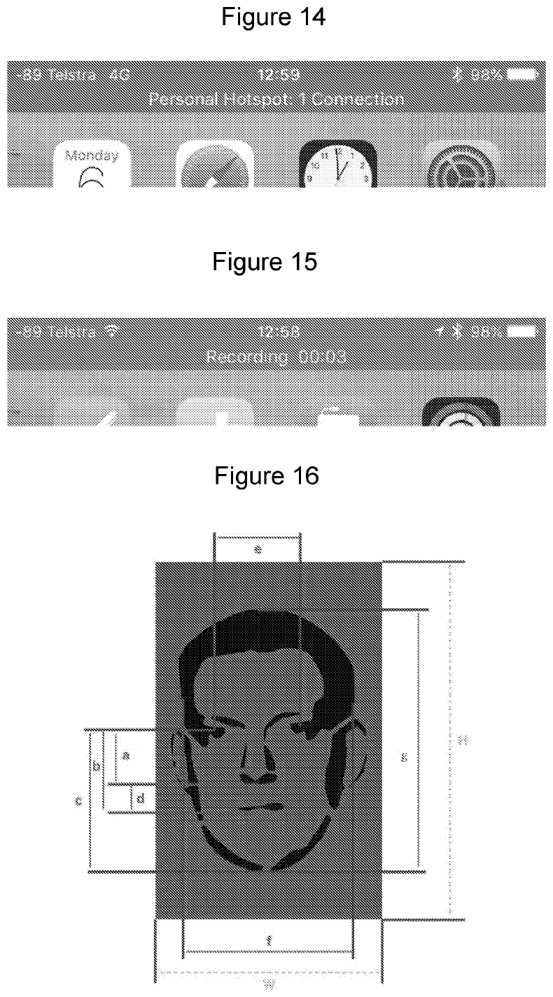

FIGS. 14, 15 and 16 show different background sessions officially supported by the current Apple iOS (iOS 10). These are, in order: Phone Call (FIG. 14), Personal Hotspot (FIG. 15) and Audio Recording (FIG. 16).

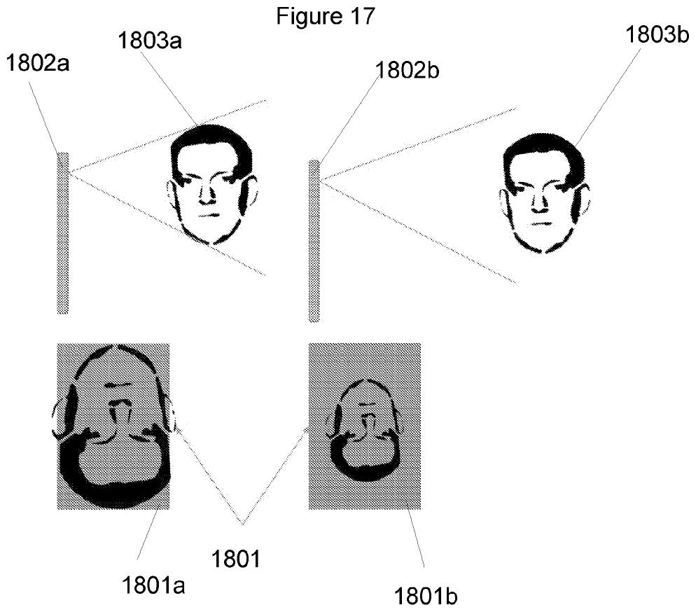

FIG. 17 shows the image sensor dimensions Height (H) and Width (W). Facial dimensions are shown using the letters a to g and the image is measured by a light sensor, using a user-facing camera. Forward facing camera sensor data is transferred to the device and the device software is used to determine the relative distance between facial features, and total sensor size. The device software can also be used to determine the relative orientation of the phone to the user's face. Outputs are used to determine distance from face, and rate of change of distance. These outputs are usable as inputs for touchless control of camera actions and functions such as zoom/crop/playback speed and direction and the like.

FIG. 18 shows example image sensor readings using the facial image shown in FIG. 17. 1801 shows the camera image sensor data in graphical format. Two scenarios are shown in FIG. 18, scenario “a” where the user 1803a is closer to the phone and scenario “b” where the user 1803b is further away from the device. In scenario “a” it can be seen that the user 1803a fills a larger part of the sensor 1801a. In scenario “b” it can be seen that the user 1803b fills a smaller part of the sensor 1801b. By continually measuring the sensor readings and determining the differences between the readings, it is possible to control phone settings including the camera settings and functions such as zoom, clip, replay as described above. All the camera and phone features can be controlled by measuring sensor readings as described.

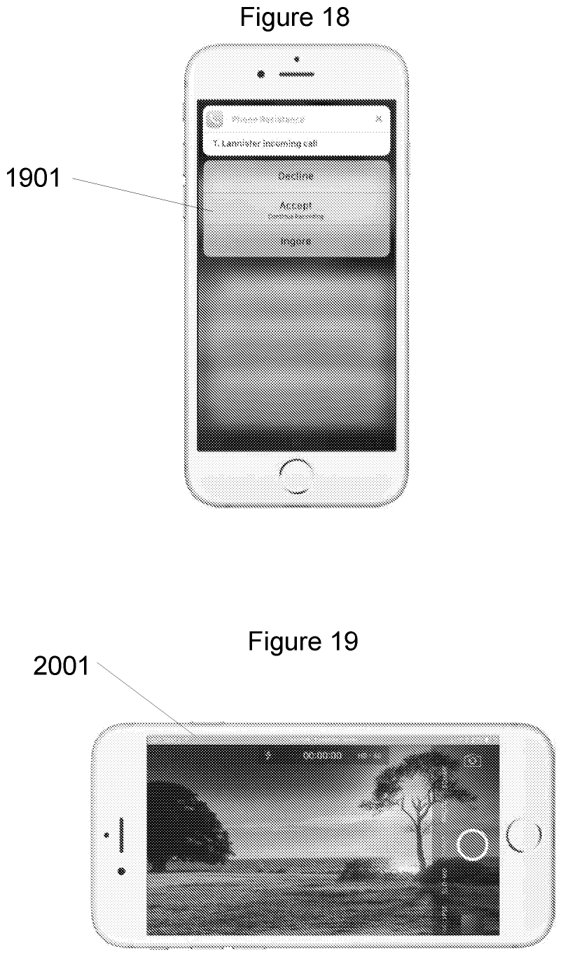

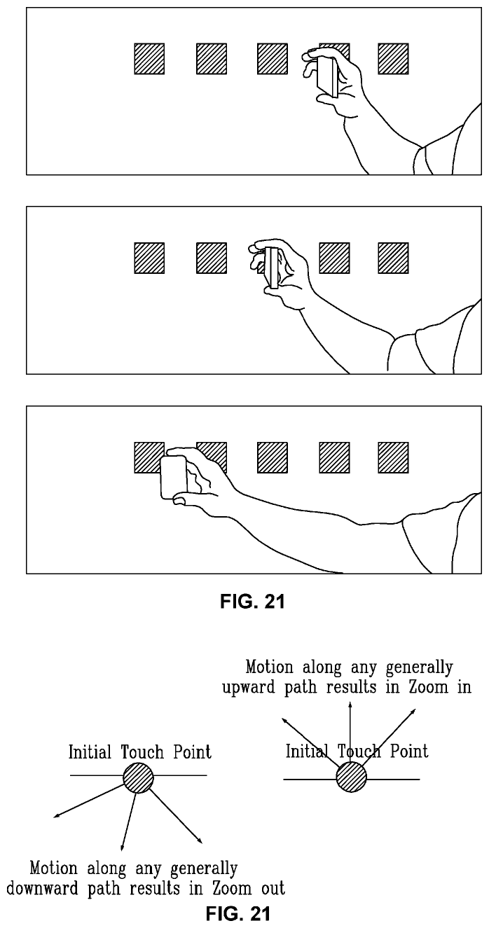

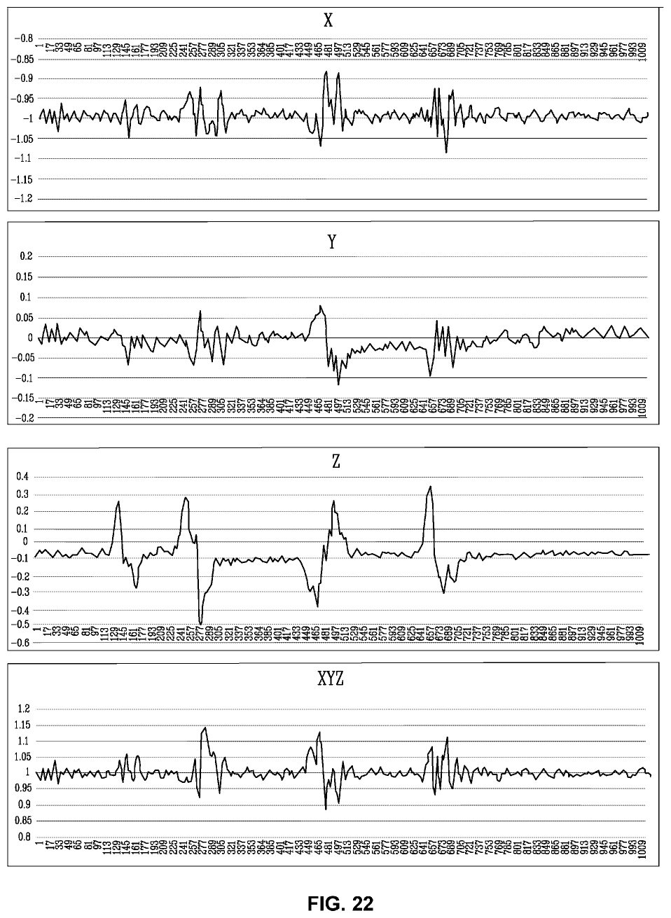

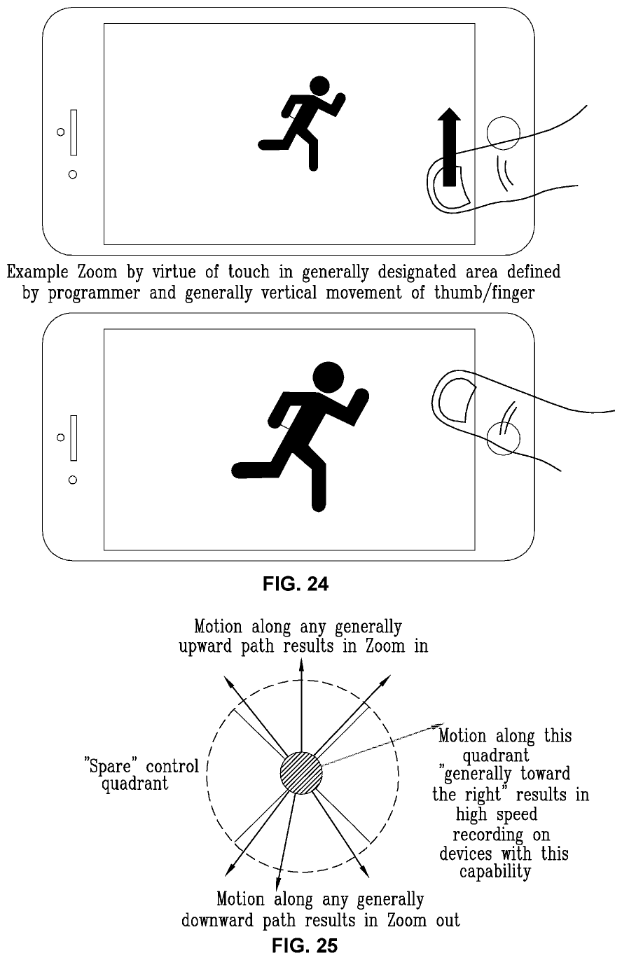

FIG. 19 shows the user interface for the telephone call resistance feature. Without this feature, recording is interrupted when a telephone call is received. In some devices recording is paused and in some devices the recording is lost. In the preferred embodiment when the mobile phone receives a telephone call, an option menu 1901 pops up on the user display to allow the user to make the decision what to do, the choices being decline the call, accept the call (continue recording) and ignore the call. The user can continue to record without any video loss, ignore the call and continue recording or take the call and continue recording. Regardless of the user's choice the video will continue recording in the preferred embodiment. It is preferred that this feature is turned on by default but it can be provided as an option to the user. This feature is used, but not limited, to landscape and portrait mode, duo-screens, back screen, any primary or secondary screen and any combination of the above. In the scenario where the user elects to use the microphone to speak during the call, the user is provided with the option to stop audio recording but to continue with video recording.

Referring to FIG. 20 if the user chooses to answer the call, the recording interface and video record continues and the green bar on top indicates that a voice call is running in background. The name of the caller and source device (from contact list) is displayed on top of the user display. The green bar style 2001 aligns with Apple current design for background section. This feature includes, but is not limited to, the above user interface layout to implement the feature.

In another embodiment the phone operating system, in this case 10S, allows the user to swipe up to reach a menu that enables toggling of airplane mode. Airplane mode allows the user to selectively turn on or off the phone's antennas. As an enhancement, users are given the option to activate and select phone call resistant options. Users can select one of the predetermined options or none at all. In one basic option, when the camera is activated, the phone is automatically set to airplane mode, and when the camera is de-activated, the phone automatically deactivates airplane mode. In this way the phone disconnects from the telephone network when the camera is activated and the phone is therefore unable to receive or make calls until the recording is stopped. Further embodiments provide alternative options. In one embodiment, the user can select a predetermined time in which to exit airplane mode. For example, if the predetermined time is 5 minutes, after 5 minutes the phone will automatically switch out of and deactivate airplane mode. A pop-up can appear onscreen so that users can still opt out of returning to normal mode (that is, snooze the switch back to normal non airplane mode for say another 5 minutes) if they are still recording and don't wish to be interrupted. This helps ensure that the phone returns to normal operation unless otherwise selected by the user.

In another embodiment there is a delay in switching back to normal operation and out of airplane mode to prevent the phone going in and out of a connected state if say the user is waiting to capture video such as for that perfect moment (say at a soccer match, when the ball is close to the competing teams nets, and users are putting cameras up and down in anticipation).

Embodiments of the invention provide a number of advantages including: fact camera activation allowing a better chance of capturing desired photos and videos; better chance of capturing the moment and better able to generate monetary returns and kudos; better capture quality as the user does not need to touch the camera screen leading to better stability of the device; simple to use trim options; edits to only user defined high impact premium content; easy to use control capabilities including zoom and playback controls leading to better quality footage and a better viewing experience; simplified sharing that ensures first to market advantage.

Possible features of embodiments of the invention and associated advantages are provided in the following table.

| | | |
|---|---|---|
| Feature | Mechanisms of action: | Advantage |

Any of, or any combination of:

| | | |
|---|---|---|
| One-Step Startup | Orientation Sensing | Fastest reaction time |
| | Predefined device motion sequence | when user need to record |
| | User defined motion sequence | something of interest. |
| | Light sensing | Easier to use. |
| | Face detection using user facing camera | |
| | User Facial Gesture Recognition (E.g. like smile | |
| | recognition), typically using user-facing camera, if user | |
| | facing camera detects face at any time | |
| | User voice command | |
| One-Step Stop or Pause | Orientation Sensing | One-Step Stop or Pause |
| | Predefined device motion sequence | |
| | User defined device motion sequence | |
| | Light sensing | |
| | User Facial Gesture Recognition (E.g. like smile | |
| | recognition), typically using user-facing camera | |
| | User voice command | |
| Touchless Control | Facial distance detection using: | Better video recording |
| (no requirement to touch | Image size analysis using data from user facing | quality (no impact forces |
| device screen and/or | camera - via determine of view angle occupied by an | on device as caused |
| control buttons), which | image characteristic, for example face size, face height, | when touching screen |
| may be used to control, | distance between eyes, eye-nose-eye triangle, | based on physical |
| for example, when | eye-mouth-eye triangle, etc. If the users face is further | buttons). Intuitive. Easier |
| recording (zoom in, zoom | away, the view angle will be smaller | to use. |
| out), when capturing | Sonic based distance measurement (Future devices - | |
| picture in video | like ultrasonic tape measure) | |
| (cropping), when replaying | Laser based distance measurement (Future devices - | |
| video (fast forward, | like laser tape measure) | |
| reverse play, fast rewind) | Rate of change of facial distance, using data per above | |
| | distance measuring mechanisms. | |
| | User Facial Gesture Recognition (E.g. like smile | |
| | recognition), typically using user-facing camera | |
| | User voice command | |
| 1-Step multi option, and/or | Screen based buttons | 1-Step multi option, |
| automatic video trimming | Device based buttons | and/or automatic video |
| (during any or all of: | User Facial Gesture Recognition (E.g. like smile | trimming (during any or |
| Recording, Post | recognition), typically using user-facing camera | all of: Recording, Post |
| recording, during pause, | User voice command | recording, during pause, |
| during playback or | | during playback or |
| playback pause, etc) | | playback pause, etc) |

Embodiments of the invention consider controls of camera zoom and other functions by determining distance to the users face. This provided for touchless control of the zoom function, and other camera functions.

Further ideas and methods have been developed to provide for such touchless, and low-touch controls of the camera zoom function. In addition to control of the camera zoom functionality, such controls are also relevant to controlling device functions such as: a) Camera zoom during photo and video capture; b) Photo and video zoom level control during playback; c) Photo and Video cropping; d) Video and audio playback speed control; e) Video reverse speed control; f) Video play direction control; g) Photo Album Review.

### Further Embodiments

A number of current embodiments have been developed relating to photo and video zoom controls for photo and video capture, photo and video review, photo and video image cropping.

In version 1, accelerations and/or rates of acceleration generally away from and generally towards the user (and/or subject matter if used for video and/or photo capture) are measured using device sensors. Acceleration direction may or may not be differentiated along 1, some or all axes.

As an example alternative to the above, the user may hold the device overhead, and move the device forward to initiate a zoom action. Acceleration levels are measured during device movement. When acceleration level/s and/or rate of change of acceleration level/s are above a certain threshold value and/or absolute threshold value, then trigger an action. These may include:
Action 1. Initiate camera zoom in, all the way to a defined limit
Action 2. Initiation camera zoom out, all the way to pre-zoom level.

Threshold values of acceleration levels and/or rate of change of acceleration levels and/or time intervals are used to avoid accidental initiation of possible actions.

Data Processing may be performed to obtain a better effective signal to noise ratios (in this case the signal data is the sensor data delivered by the sensor following a user movement intended to initiate zoom)

Once initiated, Zoom in and zoom out actions follow a pre-defined or user defines response curve, which can include, but are not limited to any or any combination of the following:
Constant zoom rate
Parabolic zoom rate
Semi-parabolic zoom rate
Accelerating and/or decelerating zoom rate
Decaying zoom rate

Version 1b is similar to version 1, but threshold values are reduced so as to trigger Actions 1 and 2 at a lower threshold value. Reducing threshold values may increase the incidence of unintended Action 1 or Action 2.

To counter this, programming code is written to ensure that zoom action will only be initiated and/or continued unless the user touches the device touchscreen and/or or a physical button or switch.

In version 2, accelerations and/or rates of acceleration generally away from and generally towards the user (and/or subject matter if used for video and/or photo capture) are measured.

As an example alternative to the above, the user may hold the device overhead, and move the device forward to initiate a zoom action. Time based Acceleration direction, and or rate of change of directions, and general acceleration curve shape is determined by programmatic analysis the measured data.

Analysis outputs and analysis of the device state is used to define intention to do one of four possible actions:
Initiate zoom in
Stop Zoom in
Initiate zoom out
Stop Zoom out.

Threshold values of acceleration levels and/or rate of change of acceleration levels and/or time intervals are used to avoid accidental initiation of possible actions.

Data Processing may be done to obtain a better effective signal to noise ratios (in this case the signal data is the sensor data delivered by the sensor following a user movement intended to initiate zoom)

Zoom in and zoom out actions follow a pre-defined or user defines response curve, which can include, but are not limited to any or any-combination of the following:
Constant zoom rate
Parabolic zoom rate
Semi-parabolic zoom rate
Accelerating and/or decelerating zoom rate
Decaying zoom rate
Etc.

Version 2b is similar to version 2, but threshold values are reduced so as to trigger Actions at lower threshold values. Reducing threshold values may increase the incidence of unintended Action 1 or Action 2.

To counter this, programming code is written to ensure that zoom action will only be initiated and/or continued unless the user touches the device touchscreen and/or or a physical button or switch.

In version 3, time based accelerometer measurements from the device are collected and analysed. In addition, time based gyroscope sensor measurements from the device may be collected and analysed. In addition, time based magnetic field sensor data from the device may be collected and analysed. Additional sensor data provides additional data for better analysis and programmatic assessment of user device motion and intentions

Analysed results based on measured data are used to determine the following:
Acceleration directions and trends.
Differentiation type analysis to determine rate of change of acceleration (jerk force) directions and trends.
Integration type analysis to determine indicative speed, speed trends and indicative distance moved.

Further analysis, as required, of all of the above to determine and/or cancel out the effects of further variables such as, for example:
Acceleration sensor noise
Gravitational effects
Angular motion effects
Centrifugal motion effects
User motion effects (where such motion is unrelated to the motion required to initiate and/or control the zoom functionality).

Analysis outputs are used individually and/or in combinations, both dependent of, and independently of, device state, to provide control of camera zoom features.

Acceleration and/or rates of acceleration generally away from and generally towards the user (and/or subject matter if used for video and/or photo capture) are measured.

Acceleration direction, and general acceleration curve shaped is determined.

Analysis determines acceleration direction and or rate of change of directions.

Data Processing may be done to obtain a better effective signal to noise ratios (in this case the signal data is the sensor data delivered by the sensor following a user movement intended to initiate zoom)

Analysis of data and device state is used to interpret intention to do one of 4 possible actions.
Initiate zoom in
Stop zoom in
Initiate zoom out
Stop zoom out.

Analysis or data and device state is also used to interpret intention with respect to:
Zoom in/Zoom out speed
Zoom in/Zoom out extent

Threshold values of acceleration levels and/or rate of charge of acceleration levels and/or time intervals are used to avoid accidental initiation of possible actions.

Zoom in and zoom out actions follow a pre-defined or user defines response curve, which can include, but are not limited to any or any-combination of the following:
Constant zoom rate
Parabolic zoom rate
Semi-parabolic zoom rate
Accelerating and/or decelerating zoom rate
Decaying zoom rate
Etc.

Version 3b is similar to version 3, but zoom activation threshold values are reduced so as to trigger Actions at lower threshold values. Reducing threshold values may increase the incidence of unintended Action 1 or Action 2.

To counter this, programming code is written to ensure that zoom action will only be initiated and/or continued unless the user touches the device touchscreen and/or or a physical button or switch.

Drawing 21: Example photos indicating an example of general device movement that users would like to initiate camera zoom functions. In this case accelerometer and/or gyroscope and/or other sensor data is analysed and used to activate and/or control the camera zoom function.

Drawing 22: Sample Accelerometer data from mobile phone: In this example, the 3^{rd} chart most clearly shows data peaks indicating user intentions when performing a specific type of motion to initiate and/or control zoom functionality.

Touch Activation controller for versions 1b, 2b and 3b: A screen based controller may also be applied independently to initiate zoom and other functions.

In a preferred embodiment, the controller allows the user to touch the screen anywhere with a finger or stylus, and simply slide the finger towards the top or bottom of the screen, at any angle.

The general operational protocol is as follows:
Touch anywhere in a general designated screen area. In the current embodiment this is close to the right hand side of the screen for right-handed operation.
If the touch is a single touch with immediate release—then there is no effect other than the device camera to continuing to apply standard camera function for such a touch. Typically a single touch is applied to adjust lighting levels and the focus point.
If after touching, the user keeps finger on screen, then embodiment versions 1b, 2b and 3b, may be programmatically enabled.
If after touching, the user slides the finger in any direction, but generally trending upwards—Zoom in towards subject matter. Zoom level set once finger removed from screen. Any further similar swipe/s provide further zoom in, until device limit reached.
If after touching, the user slides the finger in any direction, but generally trending downwards, then Zoom out. Zoom level set once finger removed from screen. Any further similar swipe/s provide further zoom out, until device limit reached.
A user can for example also touch, slide up, and without lifting the finger, slide down again. In this example instance the camera will zoom in and then zoom out.
The reverse could be applied, e.g. generally up to zoom out, generally down to zoom in.

The response curve of zoom adjustment to user finger movement distance, speed, acceleration and deceleration on the screen can be programmatically and/or user defined, and could include, but is not limited to:
Scrolling zoom action. Same action as scrolling a page on a touchscreen device, except that scrolling results in zoom adjustment.
Proportional response to distance moved and/or speed of movement and/or angle of movement.
Linear response to distance moved and/or speed of movement and/or angle of movement.
None-Linear (e.g. power law, logarithmic etc.) response to distance moved and/or speed of movement and/or angle of movement.

Drawing 23: The above segments the motion to two hemispheres from the initial touch point. This method can be applied to improve the UX (user experience) for almost ANY stills or video camera interface.

Drawing 24 shows additional controls. The abovementioned is the simplest form of touch control for zoom functionality when recording either photos and/or videos. Further segmentation could be used to introduce additional controls. For example, finger motion can be further segmented so that the same controls can also be used to initiate additional features.

Drawing 25 shows further advantages of embodiments of the invention which include the following.

Use of device accelerometer data as an input for the control of camera functions including:

a) Camera zoom during photo and video capture
b) Photo and video zoom level control during playback
c) Photo and Video cropping
d) Video and audio playback speed control
e) Video reverse speed control
f) Video play direction control

### g) Photo Album Review

Use of device accelerometer and/or gyroscope data and/or electronic magnetic field sensor as an input for the control of camera and media related functions including:

a) Camera zoom during photo and video capture
b) Photo and video zoom level control during playback
c) Photo and Video cropping
d) Video and audio playback speed control
e) Video reverse speed control
f) Video play direction control

### g) Photo Album Review

Use of other sensor data, whether embedded in the device, or added as an attachment, or peripheral to the device (e.g. some mobile devices are now equipped with sonar sensors) that may be applied to assist in the determination of user motion intended to initiate a camera control function, including:

a) Camera zoom during photo and video capture
b) Photo and video zoom level control during playback
c) Photo and Video cropping
d) Video and audio playback speed control
e) Video reverse speed control
f) Video play direction control

Use of touchscreen touch to assist accelerometer and/or other sensor initiated and/or controlled zoom, and other camera and media related functions, including:

a) Photo and video zoom level control during playback
b) Photo and Video cropping
c) Video and audio playback speed control
d) Video reverse speed control
e) Video play direction control

### f) Photo Album Review

An Innovative touchscreen touch-control method, that allows for simplified control of functions such as.

a) Camera zoom during photo and video capture
b) Photo and video zoom level control during playback
c) Photo and Video cropping
d) Video and audio playback speed control
e) Video reverse speed control
f) Video play direction control

### g) Photo Album Review

In a preferred embodiment the portable electronic devices described above are shown by way of example only. However, it should be noted that the portable electronic device may be adapted for use as required and may include differing technical integers, such as different display devices, human interfaces and the like. In other words, the technical integers of the computing device are exemplary only and variations, adaptations and the like may be made thereto within the purposive scope of the embodiments described herein and having regard for the particular application of the portable electronic device. In different embodiments, the device may comprise semiconductor memory comprising volatile memory such as random access memory (RAM) or read only memory (ROM). The memory may comprise either RAM or ROM or a combination of RAM and ROM. The device may comprise a computer program code storage medium reader for reading the computer program code instructions from computer program code storage media. The storage media may be optical media such as CD-ROM disks, magnetic media such as floppy disks and tape cassettes or flash media such as USB memory sticks or downloadable by way of an application or software download. The device further may comprise an I/O interface for communicating with one or more peripheral devices. The I/O interface may offer both serial and parallel interface connectivity. For example, the I/O interface may comprise a Small Computer System Interface (SCSI), Universal Serial Bus (USB), Apple lightning connection, fire wire or similar I/O interface for interfacing with the storage medium reader. The I/O interface may also communicate with one or more human input devices (HID) such as keyboards, pointing devices, joysticks and the like. The I/O interface may also comprise a computer to computer interface, such as a Recommended Standard 232 (RS-232) interface, for interfacing the device with one or more personal computer (PC) devices. The I/O interface may also comprise an audio interface for communicate audio signals to one or more audio devices, such as a speaker or a buzzer. The device may also comprise different network interfaces for communicating with one or more computer networks. The network may be a wired network, such as a wired Ethernet network or a wireless network, such as a Bluetooth network, GSM, 3G or 4G or IEEE 802.11 network. The network may be a local area network (LAN), such as a home or office computer network, or a wide area network (WAN), such as the Internet, private WAN or mobile phone network. The device further comprises an arithmetic logic unit or processor for performing the computer program code instructions. The processor may be a reduced instruction set computer (RISC) or complex instruction set computer (CISC) processor or the like. The device further comprises a storage device, such as a magnetic disk hard drive or a solid state disk drive. Computer program code instructions may be loaded into the storage device from the storage media using the storage medium reader or from the network using network interface. During the bootstrap phase, an operating system and one or more software applications may be loaded from the storage device into the memory. During the fetch-decode-execute cycle, the processor may fetch computer program code instructions from memory, decode the instructions into machine code, execute the instructions and store one or more intermediate results in memory. In this manner, the instructions stored in the memory, when retrieved and executed by the processor, may configure the portable electronic device as a special-purpose machine that may perform the functions described herein. The device may also comprise a video interface for conveying video signals to a display device, such as a liquid crystal display (LCD), cathode-ray tube (CRT) or similar display device. The device may also comprise a communication bus subsystem for interconnecting the various devices described above. The bus subsystem may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Interpretation

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular embodiments only and is not intended to be limiting of the invention. As used herein, the singular articles “a”, “an” and “the” are intended to include the plural forms as well, unless the context clearly indicates otherwise and thus are used herein to refer to one or to more than one (i.e. to “at least one”) of the grammatical object of the article. By way of example, the phrase “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

The term “real-time” for example “displaying real-time data,” refers to the display of the data without intentional delay, given the processing limitations of the system and the time required to accurately measure the data.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” or a “portable electronic device” may include one or more processors.

The methodologies described herein are, in one embodiment, performable by one or more processors that accept computer-readable (also called machinereadable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Furthermore, a computer-readable carrier medium may form, or be included in a computer program product. A computer program product can be stored on a computer usable carrier medium, the computer program product comprising a computer readable program means for causing a processor to perform a method as described herein.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

For the purpose of this specification, where method steps are described in sequence, the sequence does not necessarily mean that the steps are to be carried out in chronological order in that sequence, unless there is no other logical manner of interpreting the sequence.

1-33. (canceled)

34. A camera including:
a body;
an image sensor for receiving an optical image created by the light and converting the optical image to image information in the form of an electrical signal;
a memory in communication with the image sensor for storing the image information;
an orientation sensor for determine the orientation of the lens with respect to the horizontal; and
an actuator for automatically actuating the camera such that at least one image is captured and stored in the memory when the orientation of the lens with respect to the horizontal is equal to or passes through a predetermined angle.

35. The camera of claim 34 wherein upon actuation the camera captures a series of images in the form of a video.

36. The camera of claim 35 including a microphone for capturing sound and converting the sound to sound information in the form of an electrical signal wherein the sound information is stored on the memory and associated with its respective image information.

37. The camera of claim 34 including a shutter release for selectively allowing light to pass through to the image sensor wherein the actuator is in communication with and automatically actuates the shutter release.

38. A portable electronic device including:
a body;
a camera mounted to the body;
an orientation sensor for determining the orientation of the camera;
an actuator for actuating the camera when the camera is oriented in a predetermined activation orientation.

39. A portable electronic device according to claim 38 wherein the camera is deactivated when the camera is oriented in a predetermined deactivation orientation.

40. The portable electronic device according to claim 38 wherein the activation orientation is between about 50 degrees and 63 degrees with reference to the horizontal.

41. The portable electronic device according to claim 40 wherein the deactivation orientation is between about 60 degrees and 64 degrees with reference to the horizontal.

42. The portable electronic device according to claim 41 where upon deactivation the user is provided with options to save and/or edit and/or distribute the photo and/or video.

43. The portable electronic device according to claim 42 wherein the user can select, without touching the user interface, at least one option from the following: photo cropping, video replay speed; video replay; video rewind; video fast forward; video clipping; video editing; photo clipping; photo editing; and zoom.

44. A portable electronic device including:
a display for displaying at least one image to a user;
a camera to take a photo of the user's face wherein the image displayed on the display is edited according to the characteristics of the user's face.

45. The portable electronic device according to claim 44 wherein editing is done according to changes in the characteristics of the user's face, including one or more of; the user's face height to screen height ratio; the height and/or width and/or length of the users face as determined by a camera sensor; and the rate of change of the face height to screen height ratio.

46. The portable electronic device according to claim 45 wherein a camera sensor is used to determine at least one of: the distance of the user's face from the portable electronic device, and the speed of movement of the user's face relative to the portable electronic device.

47. The portable electronic device of claim 46 wherein the at least one image is edited by way of shake sequences and/or facial gestures and/or voice commands.

48. The portable electronic device according to claim 47 wherein the at least one image forms a video and the video displayed on the display is edited to: replay and/or rewind and/or forward the video; adjust the replay speed slower and/or faster of the video; change the zoom in and/or out of the video.

49. The portable electronic device of claim 45 wherein the changes in characteristics of the user's face are monitored by means of: using the front facing camera of the device; facial gestures determined by the front facing camera of the device including detection of eye blink sequences; and voice activation using specific works and/or sounds.

50. A portable electronic device including: a body; a camera mounted to the body; an orientation sensor for determining the orientation of the camera; and an actuator for actuating or deactivating the camera according to predetermine activation criteria.

51. A portable electronic device according to claim 50 wherein the activation criteria include one or more of the following individually or in combination: raise to start; light sensing; machine learnt predefined motion; machined learnt adaptive motion; gesture recognition; facial distance determination; facial recognition; voice recognition; and sound recognition.

52. A portable electronic device including: a body; a camera mounted to the body; a sensor for determining at least one activation or deactivation criterion; and an actuator for actuating or deactivating the camera according to the activation or deactivation criteria.

53. The portable electronic device of claim 52 wherein the sensor is one or more of the following individually or in combination: orientation sensor; light sensor; motion detector; global positioning system; proximity sensor; sound sensor; touch sensor.

54. The portable electronic device of claim 53 wherein the criterion include one or more of the following individually or in combination: raise to start; light sensing; machine learnt predefined motion; machined learnt adaptive motion, gesture recognition; facial distance determination; facial recognition; voice recognition; and sound recognition.

55. The portable electronic device of claim 54 wherein a user can control predetermine device controls without touching the user interface by way of the one or more sensor readings, the controls including one or more of the following: photo cropping, video replay speed; video replay; video rewind; video fast forward; video clipping; video editing; photo clipping; photo editing; and zoom.

56. The portable electronic device of claim 55 wherein at least one of the controls is provided to the user once the camera is deactivated and wherein the controls are controlled by way of one or more of the sensor readings.

57. The portable electronic device of claim 56 wherein at least one of touchless clipping control, touchless editing control, and touchless zoom are provided to the user once the camera is deactivated.

58. A camera including:
a body;
an image sensor for receiving an optical image created by the light and converting the optical image to image information in the form of an electrical signal;
a memory in communication with the image sensor for storing the image information;
an orientation sensor for determine the orientation of the lens with respect to the horizontal; and
an actuator for automatically actuating the camera such that at least one image is captured and stored in the memory when the orientation of the lens with respect to the horizontal is equal to or passes a predetermined angle or an adaptively derived angle derived through multiple factor-based computation.
